(19) United States
(12) Patent Application Publication
(10) Pub. No.: US 2013/0198632 A1
(43) Pub. Date: Aug. 1, 2013

(54) SYSTEM AND METHOD OF GENERATING A PLAYLIST BASED ON USER POPULARITY OF SONGS THEREIN THROUGH A MUSIC SERVICE

(71) Applicant: David Hyman, Kensington, CA (US)

(72) Inventor: David Hyman, Kensington, CA (US)

(21) Appl. No.: 13/754,506

(22) Filed: Jan. 30, 2013

Related U.S. Application Data
(60) Provisional application No. 61/592,010, filed on Jan. 30, 2012.

(51) Int. Cl. G06F 3/0484

(52) U.S. Cl. CPC G06F 3/04847
USPC 715/716

(57) ABSTRACT

A method includes inputting a seed data via a music interface associated with a music service on a music device through a user thereof. The seed data is a driver of creation of a playlist associated with the music service. The method also includes determining popularity of songs related to the seed data on a music server based on a usage history of the user with respect to the seed data. The music server is configured to generate the playlist. Further, the method includes providing a capability to the user to control a ratio of popular songs in the playlist related to the seed data on the music interface through another interface therefor.

### CLAIM OF PRIORITY

This non-provisional application is a conversion application and claims priority from U.S. Provisional Patent Application No. 61/592,010 titled SYSTEM AND METHOD OF GENERATING A PLAYLIST BASED ON A POPULARITY OF A SONG OF AN ARTIST filed on Jan. 30, 2012.

### FIELD OF TECHNOLOGY

This disclosure relates generally to music service(s) and, more particularly, to generating a playlist based on user popularity of songs therein through a music service.

### BACKGROUND

A user (e.g., a music fan) may be exposed to hit songs of an artist through a radio station, a subscription service (e.g., Napster®, Rhapsody®) and/or a streaming music service (e.g., Pandora®). The user may purchase hit songs through a music service (e.g., Apple®'s iTunes). A hit song may be a recorded song or an instrumental released as a single that is popular with respect to a music chart.

The user may initially be interested in a particular artist due to a hit song thereof; however, the user may begin to lose interest in the artist if the user is overexposed to the hit song. Additionally, as the user becomes more familiar with the artist (e.g., through reading up information related to the artist) and the hit song thereof, the user may want to listen to other songs (e.g., obscure songs) by the same artist.

### SUMMARY

Disclosed are a method, a device and/or a system of generating a playlist based on user popularity of songs therein through a music service.

In one aspect, a method includes inputting a seed data via a music interface associated with a music service on a music device through a user thereof. The seed data is a driver of creation of a playlist associated with the music service. The method also includes determining popularity of songs related to the seed data on a music server based on a usage history of the user with respect to the seed data. The music server is configured to generate the playlist. Further, the method includes providing a capability to the user to control a ratio of popular songs in the playlist related to the seed data on the music interface through another interface therefor.

In another aspect, a system includes a music server, a network, and a music device communicatively coupled to the music server through the network. The music device includes a music interface associated with a music service to enable a user input seed data therethrough. The seed data is a driver of creation of a playlist associated with the music service, and the playlist is generated through the music server. The music server is configured to determine popularity of songs related to the seed data based on a usage history of the user with respect to the seed data. The music interface includes another interface associated therewith to provide a capability to the user to control a ratio of popular songs in the playlist related to the seed data.

In yet another aspect, a non-transitory medium, readable through a music device and including instructions embodied therein that are executable through the music device, is disclosed. The non-transitory medium includes instructions to enable inputting a seed data via a music interface associated with a music service on the music device through a user thereof. The seed data is a driver of creation of a playlist associated with the music service. The non-transitory medium also includes instructions to provide a capability to the user to control a ratio of popular songs in the playlist related to the seed data on the music interface through another interface therefor. Further, the non-transitory medium includes instructions to receive the playlist based on generation thereof on a music server in accordance with the controlled ratio. The playlist includes songs whose popularity is determined based on a usage history of the user with respect to the seed data.

The methods and systems disclosed herein may be implemented in any means for achieving various aspects, and may be executed in a form of a machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1A is a schematic view of a music interface, according to one embodiment.

FIG. 1B is a schematic view of the music interface of FIG. 1A with a selection tool, according to another embodiment.

FIG. 2 is a schematic view of a music device executing a client module and the music interface of FIGS. 1A-B, according to one embodiment.

FIG. 3A is an illustrative view of the usage meter of the music interface of FIG. 1A, according to one embodiment.

FIG. 3B is an illustrative view of a position of a slider on the selection tool of the music interface of FIG. 1B, according to one embodiment.

FIG. 4 is a process flow diagram detailing the operations involved in generating a playlist based on user popularity of songs therein through a music service, according to one embodiment.

Other features of the present embodiments will be apparent from the accompanying drawings and from the detailed description that follows.

### DETAILED DESCRIPTION

Example embodiments, as described below, may be used to provide a method, a device and/or a system of generating a playlist based on user popularity of songs therein through a music service. Although the embodiments have been described with reference to specific example embodiments, it will be evident that various modifications and changes may be made to these embodiments without departing from the broader spirit and scope of the various embodiments.

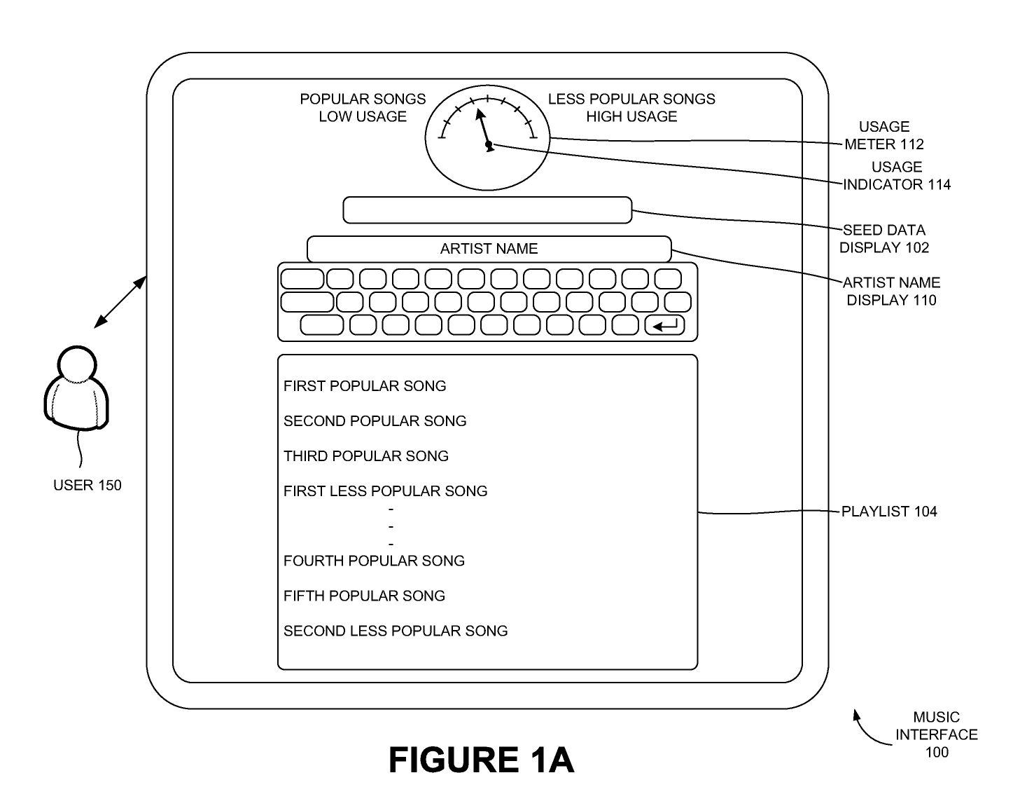

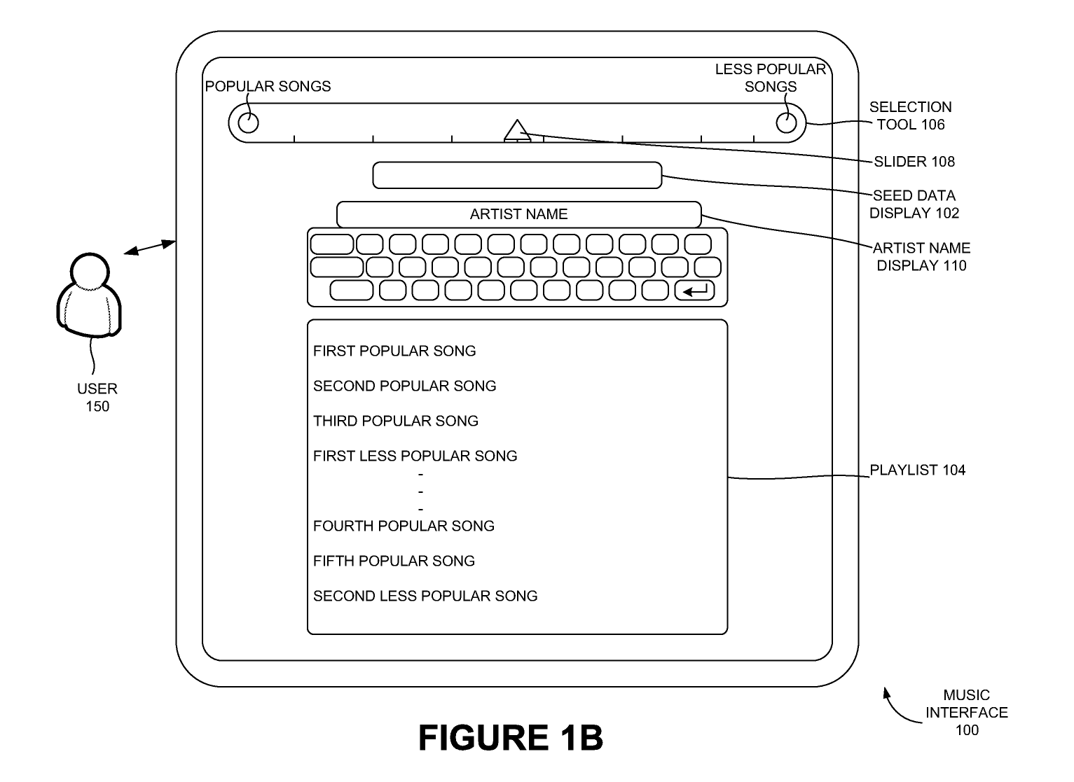

FIG. 1A shows a music interface 100, according to one embodiment. In one or more embodiments, music interface 100 may be an interface (e.g., associated with a music service) provided on a music device (to be discussed below) to enable a user 150 select and play songs based on a selection criterion. In one or more embodiments, the songs may be selected based on a seed data provided to (or, chosen by) user 150. The seed data may be an artist, an album, a song, a genre, a type of music, time frame etc., and may be a driver of creation of a playlist (to be discussed below) associated with the music service Other examples of seed data are within the scope of the exemplary embodiments. In one or more embodiments, the music device may be a data processing device such as a personal computer, a laptop computer, a notebook, a netbook, or a mobile device such as a mobile phone. Other forms of the music device are within the scope of the exemplary embodiments discussed herein. For example, the music device may be embedded in an automobile and/or in a television.

In one or more embodiments, user 150 may enter the seed data through an interface therefor on music interface 100. The input seed data may be displayed on a seed data display 102. The artist corresponding to the seed data may be displayed on artist name display 110. Once the seed data (e.g., artist) is entered, a playlist 104 including popular songs and less popular songs may be generated.

For example, the seed data may cause determination of the number of times user 150 listens to a particular artist and/or the number of times user 150 accesses songs of the particular artist. For the aforementioned purpose, music interface 100 may display a usage meter 112 and a usage indicator 114 that indicates “use” of songs of the particular artist. As user 150 listens to more songs of the particular artist, usage indicator 114 may move from a position of low usage to a position of high usage. As usage indicator 114 moves from the position of low usage to that of high usage, the composition of playlist 104 may shift from primarily including popular songs of the particular artist to increasingly including less popular songs of the same artist. When user 150 listens to the particular artist for the first time, playlist 104 may be populated with popular songs of the artist and/or popular albums thereof.

When usage indicator 114 is at the midpoint of usage meter 112, playlist 104 may include an equal number of popular songs and less popular songs of the particular artist. As usage indicator 114 shifts toward higher usage from the midpoint thereof, playlist 104 may have a greater percentage of less popular songs compared to popular songs.

A popular song may, for example, be a hit song appearing in an official music chart through repeated radio airplay and/or significant commercial sales. A popular song may be determined based on a rating of users (e.g., user 150), the commercial success of the song and/or the amount of radio airtime of the song. Popularity of songs may be determined and ranked based on radio airplay and/or commercial success. Other examples of less popular songs may include unreleased tracks, bonus tracks, non-album tracks, rare tracks, outtakes and/or exclusive tracks. The aforementioned track-types are well known to one of ordinary skill in the art. A less popular song may also be a different version of a popular song (e.g., an instrumental version, an a cappella version, a live version, an acoustic version, a remixed version).

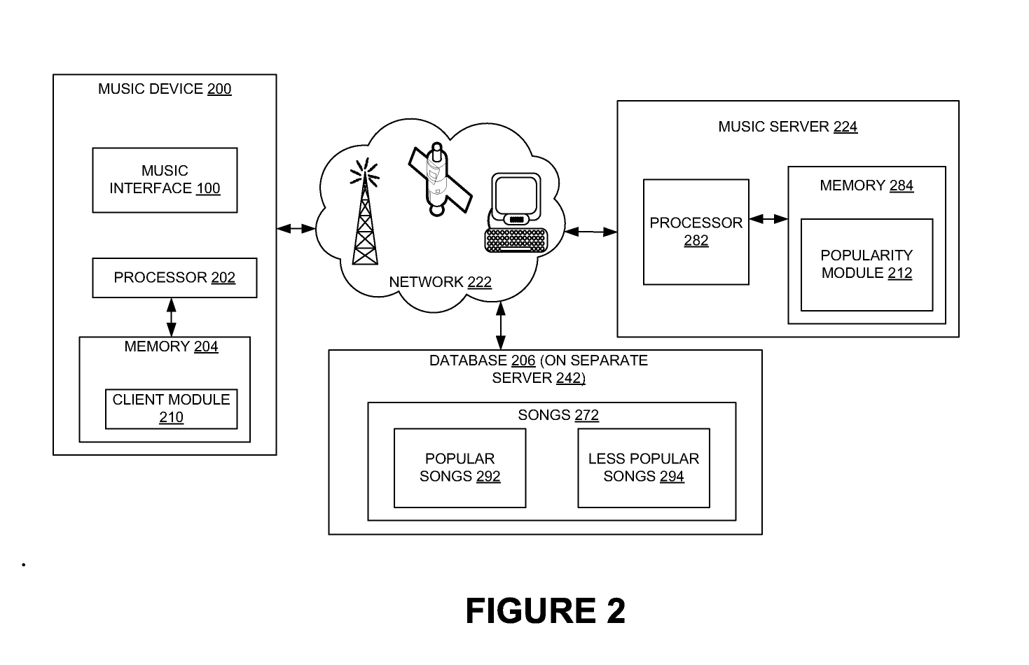

FIG. 1B shows music interface 100 with a selection tool 106, according to one or more embodiments. In one or more embodiments, user 150 may be allowed to slide a slider 108 along the axis of selection tool 106 to select a frequency of blending of popular songs and less popular songs of an artist (or, any seed data). For example, slider 108 may be slid along a vertical, a diagonal and/or a horizontal axis on selection tool 106. Other forms of selection tool 106 are within the scope of the exemplary embodiments. FIG. 2 shows a music device 200 as executing a client module 210 (e.g., on a processor 202 communicatively coupled to a memory 204 of music device 200; client module 210 is shown as being stored in memory 204) and music interface 100. In one or more embodiments, when user 150 inputs a seed data, client module 210 (e.g., a set of instructions) may transmit a request to a music server 224 for a song related to the input seed data. Based on the usage associated with user 150 and the input seed data, music server 224 may provide playlist 104 to be rendered on music interface 100 of music device 200. Playlist 104 may include popular songs and less popular songs. Again, the ratio of popular songs to less popular songs may be based on the usage and/or the selection of user 150, as discussed above.

In one or more embodiments, music device 200 may be communicatively coupled to music server 224 through a network 222. In one or more embodiments, network 222 may be a Local Area Network (LAN), Internet, a satellite communication network, a Wide Area Network (WAN) etc. In one or more embodiments, music server 224 may process request from music device 200 and fetch the requisite songs (e.g., songs 272) from a database 206 associated therewith. In one or more embodiments, music server 224 may execute a popularity module 212 (e.g., on a processor 282 communicatively coupled to a memory 284 thereof) configured to determine a popularity ratio based on the “usage” of a particular artist and/or usage indicator 114 for usage meter 112. In one or more embodiments, database 206 may include a master repository of songs and artists; database 206 may reside on music server 224 or on a separate server 242 (as shown in FIG. 2) communicatively coupled to music server 224 through network 222. Further, database 206 may include metadata of the songs and the artists of the repository (e.g., data related to commercial success of a song and/or an artist, awards related to the song and/or the artist, related songs and/or artists, popularity of musical influences). Further, in one or more embodiments, music server 224 may provide access to songs in database 206 to music device 200 through network 222.

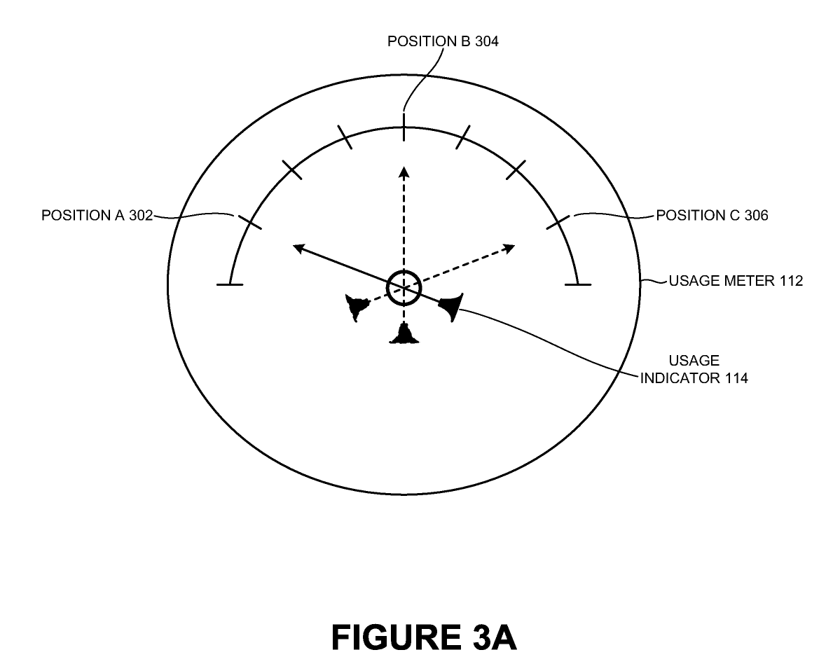

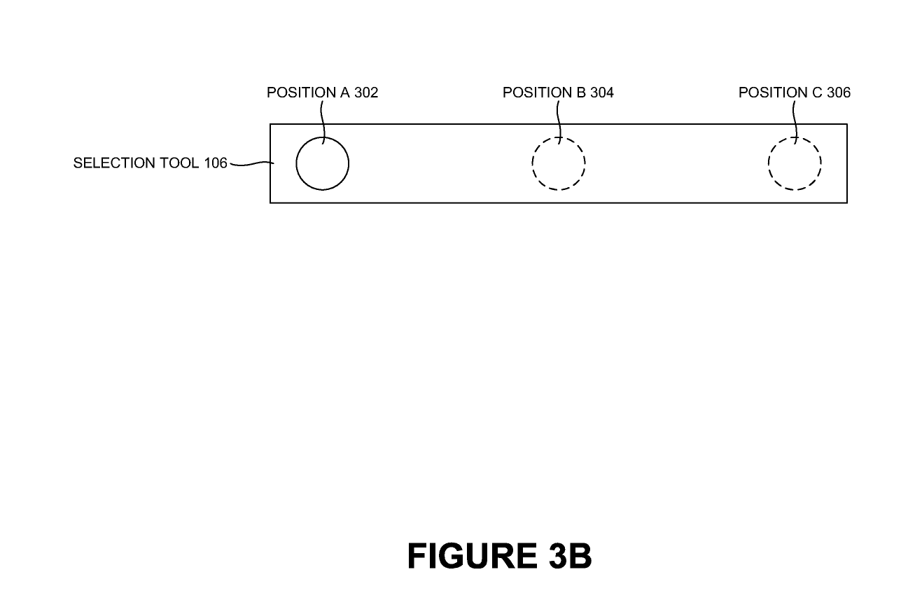

FIG. 3A shows usage meter 112, according to one embodiment. In one or more embodiments, as discussed above, usage meter 112 may include usage indicator 114 related to the popularity ratio determined in accordance with the usage. For example, at position A 302 (see FIG. 3B) indicating low “usage,” playlist 104 may include 90% popular songs and 10% less popular songs. At position B 304 indicating average “usage,” playlist 104 may include 50% popular songs and 50% less popular songs. At position C 306 indicating high “usage,” playlist 104 may include 10% popular songs and 90% less popular songs. The aforementioned percentages are merely for example purposes. The aforementioned positions A 302, B 304 and C 306 are points along the axis of selection tool 106 arrived at through selection by user 150. In one or more embodiments, based on the position of slider 108, the popularity ratio may be automatically adjusted through music device 200 and/or music server 224 (e.g., through the respective processor and memory).

In one or more embodiments, the popular songs (e.g., popular songs 292 of songs 272) and the less popular songs (e.g., less popular songs 294 of songs 272) may be blended according to a popularity ratio related to the position of slider 108 at music server 224 to generate playlist 104. In one or more embodiments, the “usage” related to an artist may be determined (e.g., at music server 224) based on the amount of time user 150 spends listening to the artist and/or the number of times of access thereof. Usage meter 112 may serve as an indicator to user 150.

In one or more embodiments, music server 224 may execute an algorithm to determine the popularity of a song based on parameters such as a rating of user 150, the commercial success of the song, and/or the amount of radio airtime of the song. Further, in one or more embodiments, the combination and/or order of the popular songs and the less popular songs of an artist may be determined by the algorithm.

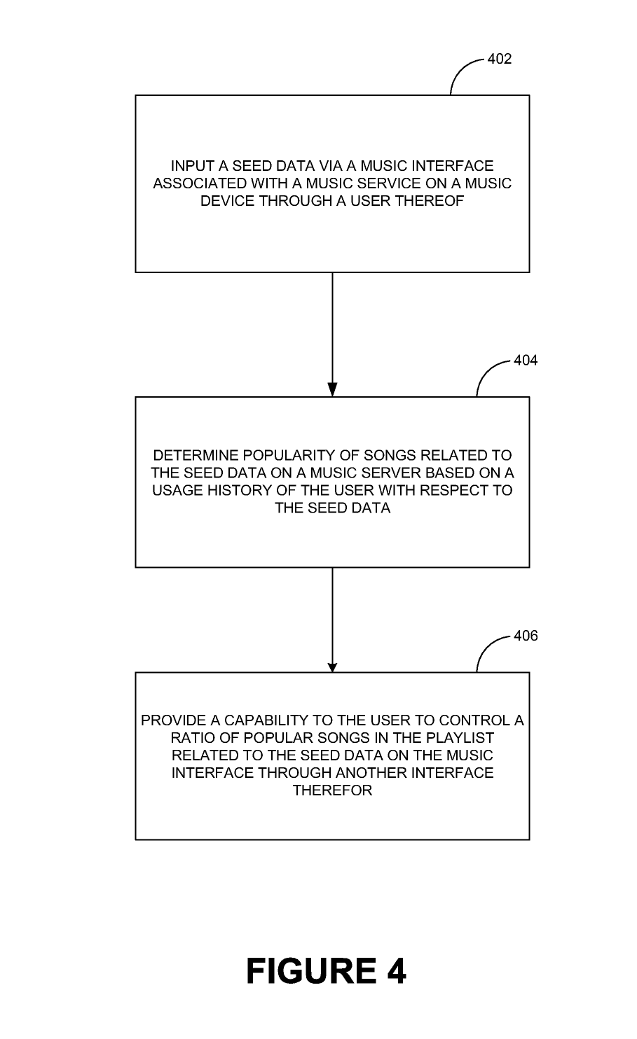

FIG. 4 shows a process flow diagram detailing the operations involved in generating playlist 104 based on user (e.g., user 150) popularity of songs therein through a music service, according to one or more embodiments. In one or more embodiments, operation 402 may involve inputting a seed data via music interface 100 associated with a music service on music device 200 through user 150. In one or more embodiments, the seed data may be a driver of creation of playlist 104 associated with the music service. In one or more embodiments, operation 404 may involve determining popularity of songs related to the seed data on music server 224 based on a usage history of user 150 with respect to the seed data. In one or more embodiments, music server 224 may be configured to generate playlist 104.

In one or more embodiments, operation 406 may then involve providing a capability to user 150 to control a ratio of popular songs in playlist 104 related to the seed data on music interface 100 through another interface therefor.

An example scenario will now be described to which concepts associated with the exemplary embodiments are applicable. A music service (e.g., “XYZ Music Service”) may be subscribed to by user 150 that wishes to access streaming music content. XYZ Music Service may primarily function as an alternative to traditional internet radio stations. User 150 may be allowed to create highly customized playlists (e.g., playlist 104) that may be designed to function as an interactive and a dynamically adaptive radio station based on the preferences thereof.

XYZ Music Service may allow user 150 to set a ratio of popular to less popular songs (e.g., based on seed data) that user 150 wishes to create playlist 104 with. The popularity may be based on the usage history of user 150 regarding songs of a particular artist, but can also be based on external data (e.g., commercial success, chart status, related music). XYZ Music Service may utilize an algorithm to generate playlist 104 having songs suited to the desired seed data of the user and/or the desired position of slider 108 on selection tool 106.

XYZ Music Service may also permit user 150 to select any song of any artist that may be stored in database 206. User 150 may stream the song instantaneously. The usage history of user 150 may be continually recorded by the XYZ Music Service in order to make the playlists (e.g., playlist 104) dynamically responsive to the preferences of user 150.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software or any combination of hardware, firmware, or software (e.g., embodied in a machine readable medium). For example, the various electrical structure and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a non-transitory machine-readable medium (e.g., a Compact Disc (CD), a Digital Video Disc (DVD), a Blu-ray® disc, a hard drive (e.g., storing a download)) or a machine accessible medium compatible with a data processing system (e.g., music device 200), and may be performed in any order (e.g., including using means for achieving the various operations). Accordingly, the specification and the drawings are to be regarded in an illustrative rather than a restrictive sense.

What is claimed is:

1. A method comprising:
inputting a seed data via a music interface associated with a music service on a music device through a user thereof, the seed data being a driver of creation of a playlist associated with the music service;
determining popularity of songs related to the seed data on a music server based on a usage history of the user with respect to the seed data, the music server being configured to generate the playlist; and
providing a capability to the user to control a ratio of popular songs in the playlist related to the seed data on the music interface through another interface therefor.

2. The method of claim 1, comprising providing the capability to control the ratio of popular songs in the playlist through a slider as the another interface, the sliding of the slider being configured to modify the ratio of popular songs in the playlist.

3. The method of claim 1, wherein songs of the playlist are stored in a database associated with the music server.

4. The method of claim 1, comprising determining the popularity of the songs on the music server based on the usage history of the user through calculating at least one of a frequency of plays of a song, a frequency of plays of an artist associated with the song, an amount of time spent listening to the song, and an amount of time spent listening to the artist.

5. The method of claim 3, further comprising:
blending songs in a popularity order through the music server; and
rendering the blended songs in the playlist generated by the music server.

6. The method of claim 5, wherein rendering the songs in the playlist comprises providing, through the music server, access to the songs in the database related to the playlist through the music interface.

7. The method of claim 1, wherein the music device and the music server are communicatively coupled through a computer network.

8. A system comprising:
a music server;
a network; and
a music device communicatively coupled to the music server through the network, the music device having a music interface associated with a music service to enable a user input seed data therethrough, the seed data being a driver of creation of a playlist associated with the music service, and the playlist being generated through the music server,
wherein the music server is configured to determine popularity of songs related to the seed data based on a usage history of the user with respect to the seed data, and
wherein the music interface includes another interface associated therewith to provide a capability to the user to control a ratio of popular songs in the playlist related to the seed data.

9. The system of claim 8, wherein the another interface is a slider, the sliding of which is configured to modify the ratio of popular songs in the playlist.

10. The system of claim 8, further comprising a database associated with the music server to store songs of the playlist.

11. The system of claim 8, wherein the music server is configured to determine the popularity of the songs based on the usage history of the user through calculating at least one of a frequency of plays of a song, a frequency of plays of an artist associated with the song, an amount of time spent listening to the song and an amount of time spent listening to the artist.

12. The system of claim 10, wherein the music server is further configured to blend songs in a popularity order and to render the blended songs in the playlist.

13. The system of claim 12, wherein the music server is further configured to provide access to the songs in the database related to the playlist through the music interface.

14. A non-transitory medium, readable through a music device and including instructions embodied therein that are executable through the music device, comprising:
instructions to enable inputting a seed data via a music interface associated with a music service on the music device through a user thereof, the seed data being a driver of creation of a playlist associated with the music service;
instructions to provide a capability to the user to control a ratio of popular songs in the playlist related to the seed data on the music interface through another interface therefor; and
instructions to receive the playlist based on generation thereof on a music server in accordance with the controlled ratio, the playlist including songs whose popularity is determined based on a usage history of the user with respect to the seed data.

15. The non-transitory medium of claim 14, comprising instructions to provide the capability to control the ratio of popular songs in the playlist through a slider as the another interface, the sliding of the slider being configured to modify the ratio of popular songs in the playlist.

16. The non-transitory medium of claim 14, comprising instructions to receive the songs of the playlist stored in a database associated with the music server.

17. The non-transitory medium of claim 14, comprising instructions to receive the songs whose popularity is determined at the music server through calculating at least one of a frequency of plays of a song, a frequency of plays of an artist associated with the song, an amount of time spent listening to the song, and an amount of time spent listening to the artist.

18. The non-transitory medium of claim 14, further comprising:
instructions to receive the songs blended in a popularity order through the music server; and
instructions to receive the playlist with the blended songs rendered therein through the music server at the music device.

19. The non-transitory medium of claim 16, further comprising instructions to access the songs of the playlist at the music device through the database via the music server.

20. The non-transitory medium of claim 14, further comprising instructions to receive the songs of the playlist at the music device through a network configured to communicatively couple the music server and the music device.
